(19) United States
(12) Patent Application Publication
(10) Pub. No.: US 2007/0119608 A1
(43) Pub. Date: May 31, 2007

(54) Illuminating adaptor for hot stick and hot stick with illuminating adaptor

(75) Inventors: Jeffrey Gardner Morris, Wheaton, IL (US); Alfred R. Flojo, P.E., Chicago, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Norcross Safety Products, L.L.C.

(21) Appl. No.: 11/287,643

(22) Filed: Nov. 28, 2005

(51) Int. Cl. H02G 7/00

(52) U.S. Cl. 174/5 R

(57) ABSTRACT

A hot stick of a type used by electrical lineworkers is equipped with an adaptor, which is mounted to one end of the hot stick. In one contemplated embodiment, the adaptor comprises a connector, which coacts with a connector mounted to the end of the hot stick so as to mount the adaptor to the end of the hot stick, and the adaptor comprises another connector, which is adapted to coact with a connector provided on a tool so as to connect the tool to the adaptor, and with light-emitting diodes for illuminating a tool so connected. In an alternative embodiment, the adaptor comprises a receptacle, which receives the end of the hot stick so as to mount the adaptor to the end of the hot stick, and the adaptor comprises a connector, which is adapted to coact with a connector provided on a tool so as to connect the tool to the adaptor, and with light-emitting diodes for illuminating a tool so connected. Preferably, in either such embodiment, the connectors are so-called “universal” connectors of a type used commonly to connect any of various tools to hot sticks.

### TECHNICAL FIELD OF THE INVENTION

This invention pertains to a hot stick of a known type, which is used by electrical lineworkers and to one end of which any a variety of tools is connected. This invention provides an adaptor, which is mountable to one end of a hot stick, and which comprises means for illuminating a tool connected to the adaptor.

### BACKGROUND OF THE INVENTION

Commonly, as exemplified in older patents including U.S. Pat. Nos. 1,920,168 and 2,643,281 and in newer patents including U.S. Pat. Nos. 6,474,197 B1 and 6,518,871 B2, electrical lineworkers use so-called “hot sticks”, which comprise dielectric poles, to manipulate any of various hooks, fuse-setting arms, pruning saws, and other tools, which are connected to distal ends of such poles via so-called “universal” connectors. Commonly, such connectors conform to recognized standards, such as ANSI standards.

Recently, Underwater Kinetics, Inc. of Poway, Calif., introduced a LITFINGER™ device, which is described in an advertisement as a “hot stick finger light” for a hot stick. The LITFINGER™ device, which is described as “patent pending” in the advertisement and which comprises a fuse-setting arm, comprises an LED (light-emitting diode) light, which is powered by three AAA alkaline or lithium batteries, for illuminating the fuse-securing arm.

### SUMMARY OF THE INVENTION

This invention provides an adaptor, which is mountable to one end of a hot stick of a type used by electrical lineworkers, and also provides such a hot stick, to one end of which such an adaptor is mounted. The adaptor comprises a connector, which is adapted to coact with a connector provided on a tool so as to connect the tool to the adaptor, and so as to connect the tool to the end of the hot stick if the adaptor is mounted to the end of the hot stick, and further comprises means for illuminating a tool so connected. Preferably, the illuminating means comprises a light-emitting diode or light-emitting diodes.

In one contemplated embodiment, the adaptor comprises a connector, which coacts with a connector mounted to the end of the hot stick so as to mount the adaptor to the end of the hot stick, and the adaptor comprises another connector, which is adapted to coact with a connector provided on a tool so as to connect the tool to the adaptor, and with light-emitting diodes for illuminating a tool so connected.

In an alternative embodiment, the adaptor comprises a receptacle, which receives the end of the hot stick so as to mount the adaptor to the end of the hot stick, and the adaptor comprises a connector, which is adapted to coact with a connector provided on a tool so as to connect the tool to the adaptor, and with light-emitting diodes for illuminating a tool so connected.

### BRIEF DESCRIPTION OF THE DRAWINGS

FIG. 1 is a fragmentary, perspective view of a hot stick, which is being held, at its proximal end, by a user who may be an electrical lineworker and which is equipped, at its distal end, with an adaptor mounting a tool, comprising means for illuminating the tool, and conforming to a first embodiment of this invention.

FIG. 2 is a partly exploded, fragmentary, perspective view of the distal end of the hot stick, the adaptor, and the tool, from FIG. 1.

FIG. 3 is a fragmentary, elevation of the distal end of a hot stick and of an adaptor mounting a tool, comprising means for illuminating the tool, and conforming to a second embodiment of this invention, as viewed from one side.

FIG. 4 is a sectional view, which is taken along line 4-4 in FIG. 3, in a direction indicated by arrows.

FIG. 5 is a simplified, electrical schematic of the illuminating means, as used in an adaptor conforming to the embodiment of FIG. 1 and as used in an adaptor conforming to the embodiment of FIG. 3.

### DETAILED DESCRIPTION OF THE ILLUSTRATED EMBODIMENTS

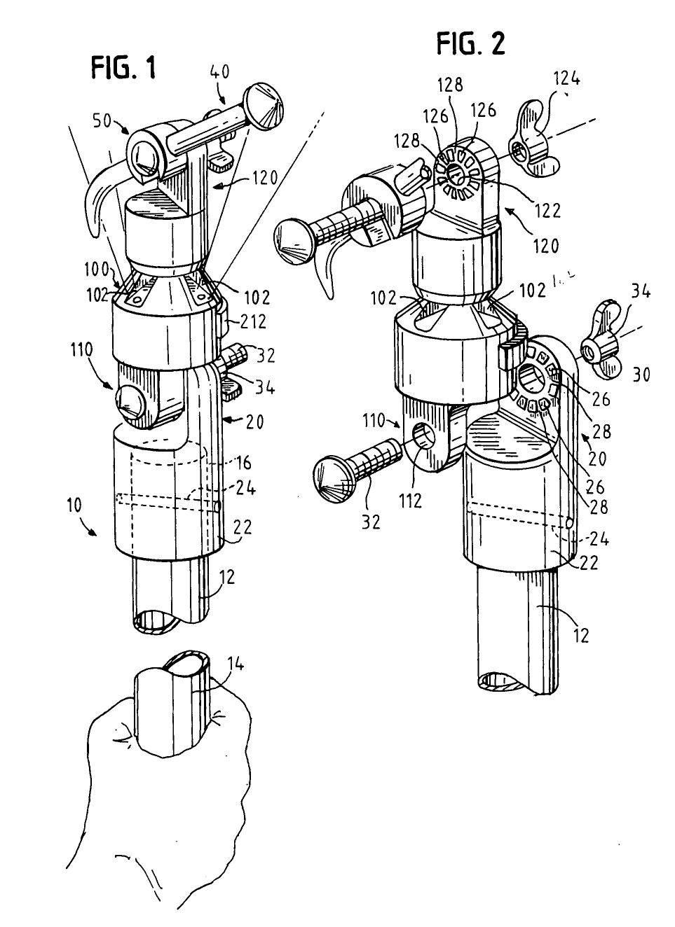

As illustrated in FIGS. 1 and 2, a hot stick 10 of the type noted above comprises a dielectric pole 12 having a proximal end 14, at which the dielectric pole 14 is held by a user, such as an electrical lineworker, and having a distal end 16, at which the dielectric pole 14 is equipped with a “universal” connector 20.

The “universal” connector 20 has a unitary receptacle 22, into which the distal end 16 of the dielectric pole 12 fits and is pinned via a cross-pin 24. The “universal” connector 20, which has an arcuate array of splines 26 alternating with slots 28 and which has a central hole 30. The “universal” connector 20 is adapted to coact in a known manner with a similar connector, which is bolted to the “universal” connector 20, via a bolt passing through the central hole 30 and through a similar hole of the coacting connector and receiving a nut, so that splines on the coacting connector fit into slots on the “universal” connector 20 and so that splines 26 on the “universal” connector 20 fit into slots on the coacting connector.

As contemplated by this invention, the hot stick 10 provided with an adaptor 100, which has two “universal” connectors, namely a lower connector 110 and an upper connector 120. Herein, the terms “upper” and “lower” and other directional terms are used for convenient reference to the drawings but are not intended to limit this invention to any particular orientation of the adaptor 100.

The lower connector 110 is adapted to coact with the “universal” connector 20, to which the lower connector 110 is bolted, via a bolt 32 passing through the central hole 30 of the “universal” connector 20 and through a central hole 112 of the lower connector 110 and receiving a winged nut 34, so that splines 26 on the “universal” connector 20 fit into slots on the lower connector 110 and so that splines on the lower connector 110 fit into slots 28 on the “universal” connector 20.

The upper connector 120, which is used to connect a tool 40 to the hot stick 10, is adapted to coact with a “universal” connector 50, which is unitary with the tool 40 and to which the upper connector 120 is bolted, via a bolt 122 passing through a central hole 122 of the upper connector 120 and through an aligned slot 52 of the “universal” connector 50 and receiving a winged nut 124, so that splines 126 on the upper connector 120 fit into slots on the “universal” connector 50 and so that splines on the “universal” connector 50 fit into slots 128 on the upper connector 120.

As contemplated by this invention, the adaptor 100 has means for illuminating the tool 40, when the tool 40 is connected to the hot stick 10, via the adaptor 40. As illustrated in FIGS. 1 and 2, the adaptor 100 has four lenses 102, two of which are illustrated and which are mounted in a generally frusto-conical region of the adaptor 100, so that the light-emitting diodes 230, when energized, illuminate the tool 40 and regions near the tool 40.

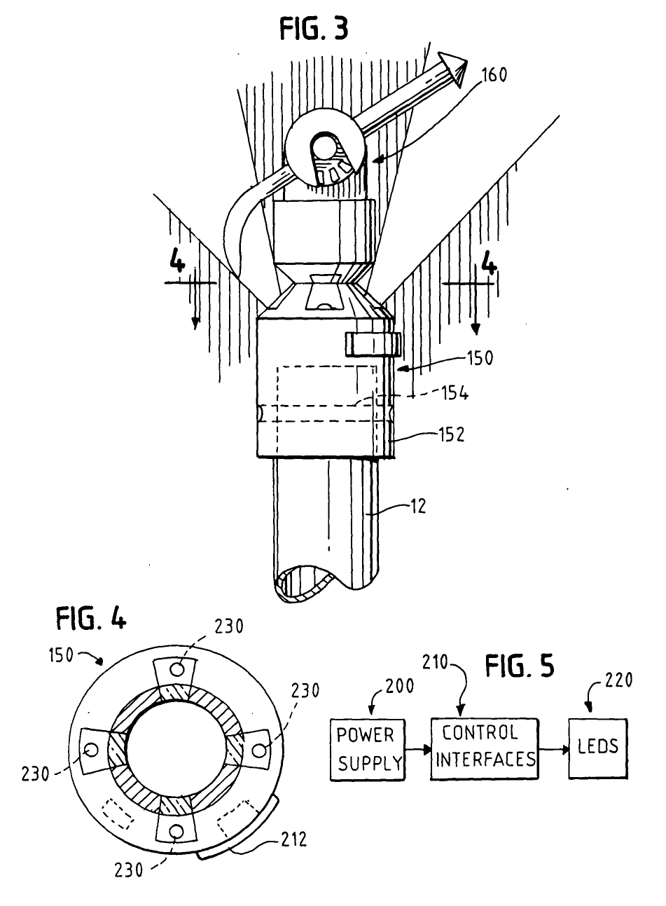

In an alternative embodiment, which is illustrated in FIGS. 3 and 4, an adaptor 150 is similar to the adaptor 100 and functions similarly, except that the adaptor 150 is not connected to the dielectric pole 12 via two “universal” connectors coacting with each other, as described above in connection with the adaptor 100. Rather, the adaptor 150 has a unitary receptacle 152, into which the distal end 16 of the dielectric pole 12 fits and is pinned via a cross-pin 154. The adaptor 150 has a “universal” connector 160, which is similar to the upper connector 120 of the adaptor 100 and which functions similarly, and an illuminating means, which is similar to the illuminating means of the adaptor 100 and which functions similarly.

As illustrated schematically in FIG. 5, the illuminating means of either embodiment described above may comprise a power supply 200, such as a battery, a control interface 210, which may include an external, on-off switch 212 and internal components, and an array of light-emitting diodes 220. Rather than an array of light-emitting diodes, an incandescent lamp may be alternatively used. Essentially, therefore, the illuminating means of either embodiment described above functions as a flashlight functions.

1. An adaptor mountable to one end of a hot stick of a type used by electrical lineworkers, the adaptor comprising a connector, which is adapted to coact with a connector provided on a tool so as to connect the tool to the adaptor, and so as to connect the tool to the end of the hot stick if the adaptor is mounted to the end of the hot stick, the adaptor comprising means for illuminating a tool so connected.

2. An adaptor mountable to one end of a hot stick of a type used by an electrical lineworker, the adaptor comprising a connector, which is adapted to coact with a connector mounted to the end of the hot stick so as to mount the adaptor to the end of the hot stick, the adaptor being equipped with another connector, which is adapted to coact with a connector provided on a tool so as to connect the tool to the adaptor, and so as to connect the tool to the end of the hot stick if the adaptor is mounted to the end of the hot stick, the adaptor comprising means for illuminating a tool so connected.

3. An adaptor mountable to one end of a hot stick of a type used by an electrical lineworker, the adaptor comprising a receptacle, which is adapted to receive the end of the hot stick so as to mount the adaptor to the end of the hot stick, the adaptor comprising connector, which is adapted to coact with a connector provided on a tool so as to connect the tool to the adaptor, and so as to connect the tool to the end of the hot stick if the adaptor is mounted to the end of the hot stick, the adaptor comprising means for illuminating a tool so connected.

4. The adaptor of claims 1, 2, or 3, wherein the illuminating means comprises a light-emitting diode or light-emitting diodes.

5. A hot stick of a type used by electrical lineworkers, the hot stick being equipped with an adaptor, which is mounted to one end of the hot stick, the adaptor comprising a connector, which is adapted to coact with a connector provided on a tool so as to connect the tool to the adaptor, and so as to connect the tool to the end of the hot stick if the adaptor is mounted to the end of the hot stick, the adaptor comprising means for illuminating a tool so connected.

6. A hot stick of a type used by electrical lineworkers, the hot stick being equipped with an adaptor, which is mounted to one end of the hot stick, the adaptor comprising a connector, which coacts with a connector mounted to the end of the hot stick so as to mount the adaptor to the end of the hot stick, the adaptor being equipped with another connector, which is adapted to coact with a connector provided on a tool so as to connect the tool to the adaptor, the adaptor comprising means for illuminating a tool so connected.

7. A hot stick of a type used by electrical lineworkers, the hot stick being equipped with an adaptor, which is mounted to one end of the hot stick, the adaptor comprising a receptacle, which receives the end of the hot stick so as to mount the adaptor to the end of the hot stick, the adaptor comprising a connector, which is adapted to coact with a connector provided on a tool so as to connect the tool to the adaptor, the adaptor comprising means for illuminating a tool so connected.

8. The hot stick of claim 5, 6, or 7, wherein the illuminating means comprises a light-emitting diode or light-emitting diodes.
